(19) United States
(12) Patent Application Publication
(10) Pub. No.: US 2007/0097861 A1
(43) Pub. Date: May 3, 2007

(54) Method for controlling and monitoring quality of service in a wireless network

(75) Inventors: Andreas Wilde, Heidelberg (DE); Stefan Schmid, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/526,570

(22) Filed: Sep. 26, 2006

(30) Foreign Application Priority Data
Sep. 27, 2005 (DE) 10 2005 046 253.7

(51) Int. Cl. H04L 12/26; H04Q 7/00

(52) U.S. Cl. 370/229; 370/329

(57) ABSTRACT

A method for controlling and monitoring the quality of service (QoS) in a wireless network wherein the network comprises at least a mobile station and wherein individual quality parameters of the service can be defined is—regarding a possibly comprehensive control of the quality of service—characterized in that in addition to the QoS of ongoing connections, the QoS for further services that concern non-ongoing connections and/or the establishment of connections are also controlled and monitored.

### BACKGROUND OF THE INVENTION

1. Field of the Invention

The present invention relates to a method for controlling and monitoring the quality of service (QoS) in a wireless network, wherein the network comprises at least one mobile station and wherein individual quality parameters of the service can be defined.

2. Description of the Related Art

In many communication systems it is necessary to ensure certain minimum requirements of services, such as voice, video or data transmission or different tasks in system management. In this sense, for example, voice data packets have to be transmitted within a defined period of time between two terminals, so that the user will not be negatively impacted by the delays of the transmission or that he will possibly not even notice them. Also, a minimum transmission rate and a maximum bit error rate have to be ensured continuously for a constant and good quality of transmitted voice data. Regarding the quality of service (QoS), and in particular in case of wireless communication systems, high requirements frequently have to be met. Hence, many communication standards already contain approaches towards QoS. Just to give an example, the two technical specifications of 3GPP regarding QoS in the UMTS network, the 3GPP TS 23.107 “Quality of Service (QoS) concept and architecture” and 3GPP TS 23.207 “End-to-end QoS concept and architecture”, have to be referred to. Many other communication standards show similar components.

QoS concepts start from very different system levels and can refer to all layers of the OSI (Open Systems Interconnection) layer model. Different quality parameters, for example, the bit rate, error rates or distribution options are defined for specific data paths.

With all the known QoS concepts, it is a problem how to deal with devices in power save mode. When a continuous specific quality of service needs to be ensured, a transition to power save mode is currently not possible, because then concrete statements about the temporal behavior of the system are not possible any longer. Due to the continuous and partly unnecessary power consumption, this is in particular critical in case of mobile terminals that in general only dispose of very restricted power resources in form of batteries, rechargeable batteries or a fuel cell.

### SUMMARY OF THE INVENTION

Hence, the present invention is based on the task to design and further develop a method of the above-mentioned kind in such a way that a quality of service can be ensured in all essential operational situations including a power save mode.

According to the invention, the task mentioned above is solved by a method showing the characteristics as recited in claim 1. According to this, the proposed method is characterized such that in addition to the QoS of ongoing connections, the QoS for further services (e.g., paging) that concern non-ongoing connections and/or the establishment of connections are controlled and monitored.

According to the invention, it has first been recognized that the conventional QoS concepts refer to ongoing connections. In particular in case of mobile stations in a power save mode, certain minimum standards are necessary when there are no ongoing connections and/or when establishing connections, in order to ensure a quality of service in and during all operational situations. According to the invention, a QoS concept was designed with which in addition to ongoing connections also non-ongoing (e.g., inactive) connections and/or the establishment of connections a QoS can be controlled and monitored.

In a particularly advantageous way the method according to the invention is not restricted to be used within a certain network only. Just to give an example, but not restricting the method to it, it should be referred to the application of the method in UMTS (Universal Mobile Telecommunications System) and WLAN (Wireless Local Area Network) according to the IEEE 802.11 standard.

The method according to the invention can be utilized in a particularly advantageous way for performing paging signaling in order to find a mobile station or in order to wake up a mobile station from the power save mode. The QoS concept could define how much time it may take to wake up a mobile station from power save mode. Furthermore, it could be defined by quality parameters how long it should take until a response of a mobile station to a paging signaling is available. Furthermore, minimum requirements can be defined stating how long it should take until a usable connection to the mobile station has to be established after a paging signaling.

In particular, the duration of an association process of a mobile station with the wireless network could be comprised.

In order to consider the conditions in the network regarding disturbances, delays from the transmission network or the like as comprehensively as possible the quality parameters can be negotiated between the network and the mobile stations. In case of an environment that is strongly impacted by disturbances, only a comparably bad error rate and a comparably low bit rate can be guaranteed. In case of very busy networks the individual users experience only a restricted bit rate. Also, in case of very long transmission paths or in case of a transmission with a lot of relay stations, only very reduced response times can be achieved. On the other side, several services require certain minimum requirements in order to enable a smooth usage of the service. For example, in case of phone calls paging should take only a short period of time, whereas for transmission of a text message a higher delay can be afforded. In order to meet all the requirements in the best possible way by considering the given environment conditions, the relevant quality parameters could be negotiated between the network and the mobile stations.

Regarding a possible storing method of the individual quality parameters, QoS profiles storing at least one quality parameter of a service could be defined. Here, a QoS profile can refer to a specific application and/or a specific service and can be assigned to the latter. A QoS profile can, for example, refer to a phone application, a data transmission application, or an SMS application. Depending on the application, different requirements become correspondingly necessary, for example for paging, it is the timing requirements of a paging signal and the subsequent reaction to this signaling. If a user waits for an important phone call, then the call should be connected to the user as fast as possible. In this case a correspondingly fast paging is wanted. However, if a user does not wait for urgent phone calls, he will tolerate rather long periods of time for paging. This applies mutatis mutandis if the mobile station comprises a sensor system, and sensor data is sent over the wireless network.

For example, if only updated system information were to be downloaded into the sensor system, a rather long period for waking up the sensor system from power save mode would be accepted. However, in case of real time measurements, a very fast reaction time is necessary, which means, that in this case much higher requirements will be set.

A QoS profile can in addition store information about the communication and/or resource context of a mobile station while the radio connection is inactive. Parts or the whole context can be stored. The network association or the UE (user equipment) context can be part of this category. This information is necessary when waking up the mobile station from the power save mode in order to reduce the time until the mobile station will again be available.

In an advantageous way the QoS profiles are configured based on the pre-settings of the user of the service. In this sense, in case of the already mentioned sensor system a considerably higher quality of service has to be ensured if a real time measurement is to be performed. If only an average value of a long-term measurement is to be retrieved from mobile sensor systems, then correspondingly longer response times can be accepted. This information can be achieved the easiest and most secure way by getting corresponding data from the user. With such data, it can for example be defined which quality parameters have to be respected under all circumstances, which parameters are, desirable, and which can be neglected if necessary.

In addition, further information can be considered by a QoS profile. For example, the priority of the respective task, the requested response time for a specific application or a specific service, or the potential real time requirements can be considered when defining the QoS profiles.

Regarding a possibly universal application of the method, the QoS profiles have a defined validity and refer to a defined part of the system. For example, a QoS profile can refer to the radio base station, to the radio access or the core network. Depending on the operational situation or the respective necessity, the QoS profile can be designed to be dynamically exchanged. This makes it possible to correspondingly adjust the quality of service depending on the respective requirements of the user. In case of the above-mentioned example of the mobile phone, the QoS profile for fast paging after reception of the urgent call would be exchanged in favor of a QoS profile with normal paging time. Alternatively or additionally, it can be envisioned to adjust the respective QoS profile according to the changed requirements. Hence, in case of the example above the respective parameter(s) could be changed in such a way that in case of an incoming phone call only a paging with normal response time is performed instead of the fast paging.

For simple manageability of the QoS profiles, a standard QoS profile can be defined which can be exchanged temporarily with another QoS profile if necessary. In case of the example above, a mobile phone with a standard paging profile can be provided with a normal paging time which can be exchanged with a profile for faster or slower paging if necessary.

At the same time, it can also be envisioned that several QoS profiles are simultaneously active. In this case the quality parameter and/or the profile, which defines the highest quality requirements, would be chosen.

QoS classes can be defined in an advantageous way based on the QoS profiles. With the QoS classes, QoS profiles that refer, for example, to a specific kind of mobile stations, applications, services or user profiles could be summarized. In this sense, different parameters are relevant for a sensor system than for a telephone service. Depending on the application executed on the mobile station, different preconditions must be met. For example, for an SMS application other parameters and criteria apply than for a telephone application.

Now, there are several options of how to design and to further develop the teaching of the present invention in an advantageous way. For this purpose, it must be referred to the claims subordinate to claim 1, on the one hand, and to the following explanation of a preferred example of an embodiment of the invention together with the figure, on the other hand. In connection with the explanation of the preferred example of an embodiment of the invention and the figure, generally preferred designs and further developments of the teaching will also be explained.

### BRIEF DESCRIPTION OF THE DRAWINGS

FIG. 1 is a schematic diagram showing a QoS architecture to support QoS for paging according to the present invention.

FIG. 2 is a schematic diagram showing a QoS architecture regarding QoS concept according to the present invention.

### DESCRIPTION OF THE PREFERRED EMBODIMENT

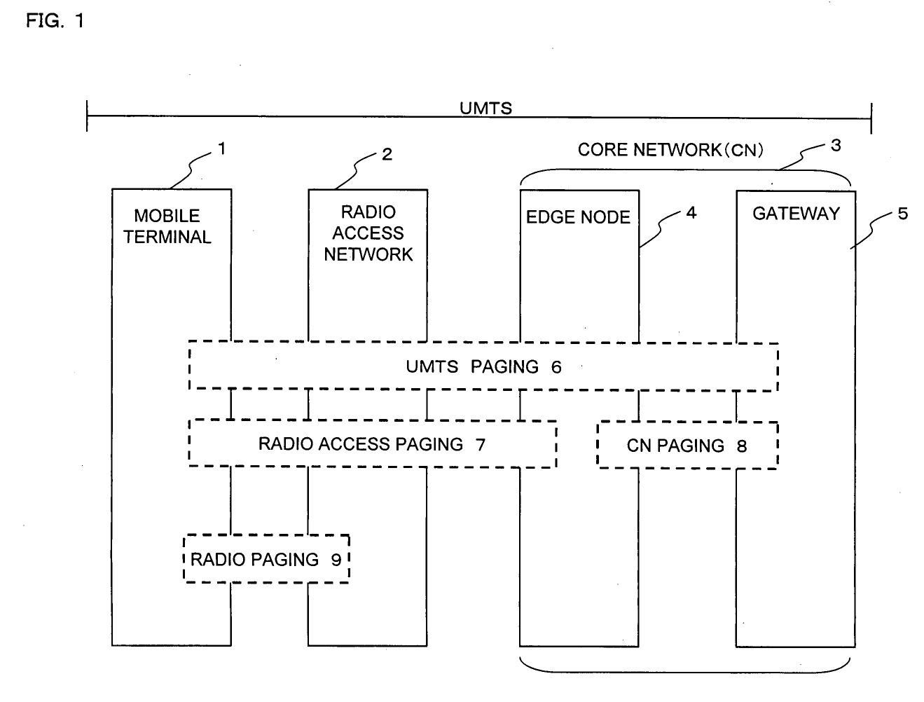

FIG. 1 shows in a schematic way the QoS architecture to support QoS for paging. As wireless network, UMTS is applied, with which a mobile terminal 1 is connected over a radio access network 2 to a core network 3. The core network 3 consists of at least one edge node 4 that is connected to a gateway 5. The different components 1, 2, 4, 5 are depicted as vertical bars.

In horizontal direction the different supported services are depicted. It becomes evident that the corresponding services cover different parts within the UTMS network. All the four network components 1, 2, 4, 5 depicted in the figure contribute to the paging signaling. In case of radio access paging 7 only the terminal 1, the radio access network 2 and the core network edge node 4 are included. In the core network 3 a core network paging 8 is provided for in addition, to which the core network edge node 4 and the core network gateway 5 contribute. On the lowest level, radio paging 9 is provided, to which the terminal 1 and the radio access network 2 contribute.

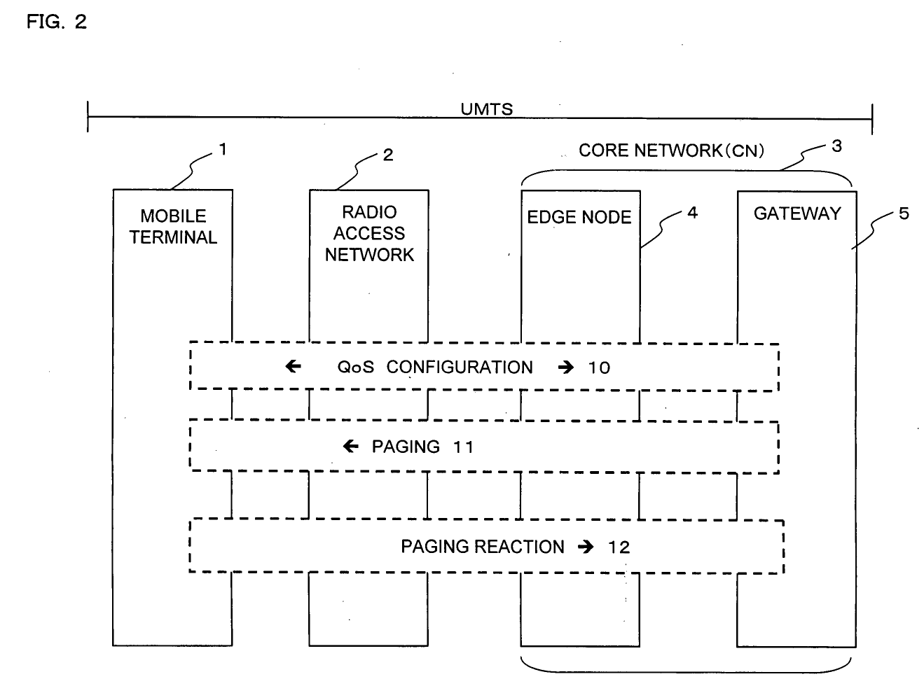

Referring to FIG. 2, the QoS Configuration 10 can be done in different ways for example:
preconfigured/prestored in the USIM or the internal Mobile Terminal memory or in the network (for example in the HSS)
negotiated between the Mobile Terminal and the Network, preferably the Core Network (for example similar to the resource reservation as described in 3GPP TS23.207 section 6.3.2.1)
update of the QoS profile or parameters based on the current Mobile Terminal situation (this can be triggered by measurements or monitoring on the network side or by specific requests from the Mobile Terminal towards the Network)

The actual transmission of a paging message from the network to the Mobile Terminal can be triggered by any part of the network (i.e. 2, 4 or 5). The paging 11 is performed using paging parameters in accordance to the active QoS profile, for example (as defined in 3GPP):
DRX cycle for Radio Paging
suitable paging group
suitable paging or tracking area

The paging parameters can affect different parts of the network 2, 4 and 5. For example the DRX cycle is typically part of the Radio Access Network 2 configuration while the paging area is typically configured by the Core Network 3.

The network may inform the Mobile Terminal about some of the parameters via system broadcast messages, via other common signalling messages or via dedicated signalling messages.

The paging reaction 12 will normally result in a message sent from the Mobile Terminal to the network, for example by transmitting a CELL UPDATE message towards the network.

Finally, it is particularly important to point out that the completely arbitrarily chosen example of an embodiment from above only serves as illustration of the teaching as according to the invention, but that it does by no means restrict the invention to the given example of an embodiment.

1. A method for controlling and monitoring the quality of service (QoS) in a wireless network wherein the network comprises at least a mobile station and wherein individual quality parameters of the service can be defined, wherein in addition to the QoS of ongoing connections, the QoS for further services that concern non-ongoing connections and/or the establishment of connections are also controlled and monitored.

2. The method according to claim 1, wherein the further services comprise paging signaling.

3. The method according to claim 1, wherein the further services comprise association processes between mobile stations or the network.

4. The method according to claim 1, wherein the quality parameters are negotiated between the network and the mobile stations.

5. The method according to claim 1, wherein QoS profiles can be defined that store at least one quality parameter of a service.

6. The method according to claim 5, wherein QoS classes are defined based on the QoS profiles.

7. The method according to claim 6, wherein QoS classes are assigned to specific types of mobile stations and/or applications and/or user profiles.

8. The method according to claim 5, wherein QoS profiles are each assigned to a specific application and/or a specific service.

9. The method according to claim 5, wherein the QoS profiles depend on the respective service to which the QoS profiles refer to.

10. The method according to claim 5, wherein the QoS profiles are defined based on the requirements of the user of the service.

11. The method according to claim 5, wherein a QoS profile has a defined validity and/or refers to a defined part of the system.

12. The method according to claim 5, wherein the QoS profiles are dynamically exchangeable and/or adjustable.

13. The method according to claim 5, wherein a standard QoS profile that is exchanged temporarily with another QoS profile is defined and active for a service.

14. The method according to claim 5, wherein in case of several active QoS profiles always the quality parameter and/or the profile is chosen that defines the highest quality requirements.
